(19) United States
(12) Patent Application Publication
(10) Pub. No.: US 2024/0379304 A1
(43) Pub. Date: Nov. 14, 2024

(54) PUSH SWITCH

(71) Applicant: Panasonic Intellectual Property Management Co., Ltd., Osaka (JP)

(72) Inventor: Yasuhira TAKIZAWA, Osaka (JP)

(21) Appl. No.: 18/691,797

(22) PCT Filed: Apr. 25, 2022
(86) PCT No.: PCT/JP2022/018690

§ 371 Date: Mar. 13, 2024

(30) Foreign Application Priority Data
Sep. 28, 2021 (JP) 2021-157356

(51) Int. Cl. H01H 13/06

(52) U.S. Cl. CPC H01H 13/06

(57) ABSTRACT

A push switch includes: a movable contact, a fixed contact that comes into contact with the movable contact, a case that includes a recessed part accommodating the movable contact and in which the fixed contact is embedded, and a rubber cap that covers the recessed part of the case. The rubber cap includes a rib that protrudes toward the case. The case further includes a lateral wall part that forms an inner surface of the recessed part. The lateral wall part has an upper surface in which a grooved part is formed. The rib is disposed in the grooved part of the lateral wall part.

### TECHNICAL FIELD

The present disclosure relates to a push switch.

### BACKGROUND ART

Push switches using a dome-like movable contact have been conventionally known as portable operation buttons (e.g., power buttons). For example, Patent Literature (PTL) 1 discloses a push switch whose crisp feel given to a user is not readily lost.

### CITATION LIST

### Patent Literature

[PTL 1] International Publication No. 2019/225635

### SUMMARY OF INVENTION

### Technical Problem

Now, push switches having waterproofness that are operable underwater have been considered. Such push switches are desired to have improved waterproofness. However, PTL 1 does not disclose improvement in waterproofness.

In view of the above, the present disclosure provides a push switch having improved waterproofness.

### Solution to Problem

A push switch according to one aspect of the present disclosure includes: a movable contact; a fixed contact that comes into contact with the movable contact; a case that includes a recessed part accommodating the movable contact and in which the fixed contact is embedded; and a rubber cap that covers the recessed part of the case. The rubber cap includes a rib that protrudes toward the case. The case further includes a lateral wall part that forms an inner surface of the recessed part. The lateral wall part has an upper surface in which a grooved part is formed. The rib is disposed in the grooved part of the lateral wall part.

### Advantageous Effects of Invention

According to one aspect of the present disclosure, a push switch having improved waterproofness can be implemented.

### BRIEF DESCRIPTION OF DRAWINGS

FIG. 1 is a perspective view of an external appearance of a push switch according to an embodiment.

FIG. 2 is an exploded perspective view of the push switch according to the embodiment.

FIG. 3 is a cross sectional view of the push switch according to the embodiment which is taken along line III-III shown in FIG. 1.

FIG. 4 is a partially enlarged cross sectional view of a dashed-line region enclosed by the dashed line shown in FIG. 3.

FIG. 5 is a cross sectional view of a rubber cap according to the embodiment.

FIG. 6 is a partially exploded view of elements in the dashed-line region shown in FIG. 3.

FIG. 7 is a partially enlarged cross sectional view of the dashed-line region shown in FIG. 3, when a push operation is performed on an operation part of the push switch according to the embodiment.

FIG. 8 is a cross sectional view of a push switch according to a comparative example taken along a line corresponding to line III-III shown in FIG. 1.

FIG. 9 is a partially enlarged cross sectional view of a dashed-line region shown in FIG. 8, when a push operation is performed on an operation part of the push switch according to the comparative example.

### DESCRIPTION OF EMBODIMENTS

### Circumstances Leading to the Present Disclosure

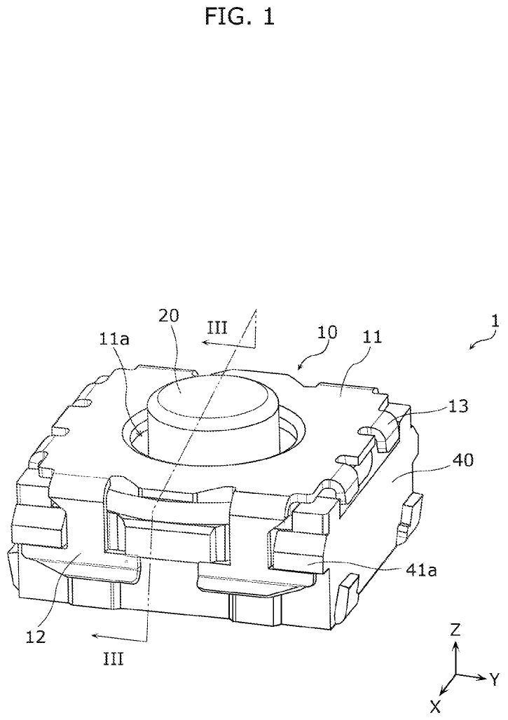

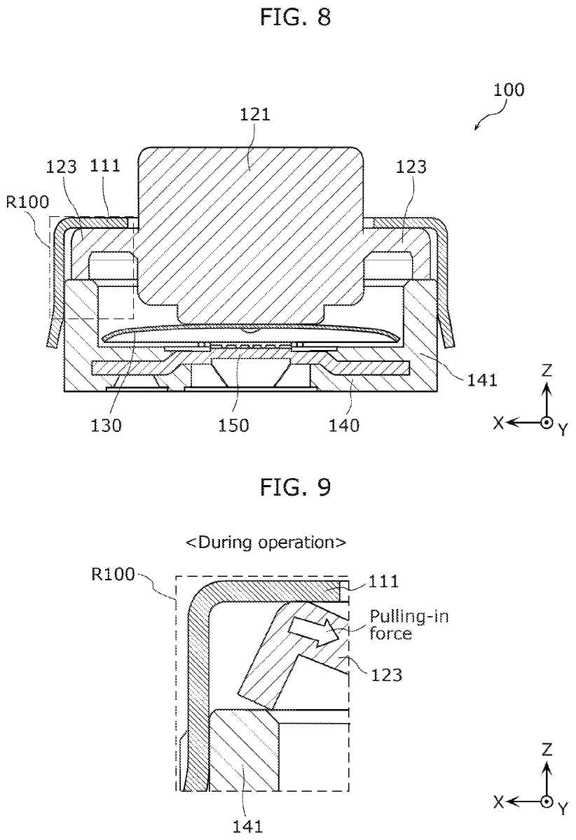

Prior to describing the present disclosure, circumstances that had led to the present disclosure will be described with reference to FIG. 8 and FIG. 9. FIG. 8 is a cross sectional view of push switch 100 according to a comparative example which corresponds to the cross sectional view of the push switch shown in FIG. 1 taken along a line corresponding to line III-III shown in FIG. 1. Note that FIG. 8 illustrates a cross sectional view of push switch 100 in a state in which no push operation is performed on push switch 100.

As illustrated in FIG. 8, push switch 100 according to the comparative example includes metallic cover 111, a rubber cap including operation part 121 and flange part 123, movable contact 130, case 140, and fixed contact 150.

Metallic cover 111 is a cover provided so as to cover flange part 123.

Operation part 121 of the rubber cap includes an exposed portion, and receives a push operation from a user. Operation part 121 is also called a push plate. Flange part 123 of the rubber cap has a cross section in the shape of a 90-degrees rotated L that is formed so as to surround operation part 121. Flange part 123 has one end connected to operation part 121 and the other end in contact with the upper surface of lateral wall part 141. Operation part 121 and flange part 123 are integrally formed. The rubber cap includes a rubber elastic body.

Movable contact 130 is an elastic plate material whose perimeter is fixed to case 140. For example, movable contact 130 is a metallic plate such as stainless steel (SUS). Movable contact 130 is, for example, a flat spring. Movable contact 130 is normally in a dome shape that protrudes toward the positive side of the Z axis. Note that normally indicates the state in which operation part 121 is not receiving a push operation.

When operation part 121 is pressed downward, movable contact 130 elastically deforms (bowed inward at the center) due to stress caused by the pressing, and comes into contact with fixed contact 150.

Case 140 has a recessed part formed by loop-like lateral wall part 141 and the bottom surface part that seals one opening of lateral wall part 141, and accommodates movable contact 130 inside the recessed part. In addition, fixed contact 150 is embedded in case 140 in a manner that fixed contact 150 can come into contact with movable contact 130 when a push operation is performed on operation part 121. Fixed contact 150 is embedded in, for example, the bottom surface part.

Fixed contact 150 is a metallic plate, and is connected to a board (printed circuit board) provided inside case 140. For example, the board is provided with electronic components, such as a power supply circuit, a control circuit, a memory, and a transmission circuit. The board detects that a push is given to operation part 121 by movable contact 130 and fixed contact 150 being brought into conduction.

In the above-described push switch 100, fixation of metallic cover 111 to case 140 in a manner that metallic cover 111 presses flange part 123 causes flange part 123 to come into contact (e.g., surface-to-surface contact) with case 140 (the upper surface of lateral wall part 141). Accordingly, push switch 100 is normally hermetically sealed with the rubber cap, as illustrated in FIG. 8.

However, push switch 100 according to the comparative example may experience a reduction in sealing performance when a push operation is performed, resulting in an occurrence of ingress of water into the recessed part of case 140. FIG. 9 is a partially enlarged cross sectional view of dashed-line region R100 shown in FIG. 8, when a push operation is performed on operation part 121 of push switch 100 according to the comparative example.

As illustrated in FIG. 9, in push switch 100 according to the comparative example, pulling-in force that pulls flange part 123 in toward the center area is generated along with a downward movement of operation part 121 which occurs when a push operation is performed. Since push switch 100 includes flange part 123 that is only in contact with the upper surface of lateral wall part 141, and does not include a mechanism for preventing a movement of flange part 123 due to the pulling-in force, flange part 123 is pulled in toward the center area and moves. Consequently, in push switch 100, sealing performance is reduced when a push operation is performed. In other words, in push switch 100, waterproofness is reduced when a push operation is performed.

In view of the above, the inventor of the present application has conducted in-depth studies on push switches that can improve waterproofness when a push operation is performed, and originated a push switch described below.

The push switch according to one aspect of the present disclosure includes: a movable contact; a fixed contact that comes into contact with the movable contact; a case that includes a recessed part accommodating the movable contact and in which the fixed contact is embedded; and a rubber cap that covers the recessed part of the case. The rubber cap includes a rib that protrudes toward the case. The case further includes a lateral wall part that forms an inner surface of the recessed part. The lateral wall part has an upper surface in which a grooved part is formed. The rib is disposed in the grooved part of the lateral wall part.

Accordingly, fitting of the rib and the grooved part together ensures adhesion between the rib and the grooved part. In addition, since a wall of the grooved part prevents a movement of the rib, it is possible to prevent a reduction in the adhesion between the rib and the grooved part along with the movement of the rib. Ensuring of the adhesion between the rib and the grooved part can prevent ingress of water into the recessed part from outside the push switch. Therefore, the present disclosure can implement a push switch having improved waterproofness.

In addition, for example, the lateral wall part may be in a loop-like shape in a top view of the push switch. The grooved part may be formed in the upper surface of the lateral wall part in a loop-like shape. The rib may be formed in a loop-like shape.

Accordingly, fitting of the grooved part formed in a loop-like shape and the rib formed in a loop-like shape together improve waterproofness of the push switch.

Moreover, for example, the rubber cap may further include a flange part that covers the upper surface of the lateral wall. The rib may be formed on the flange part. In a state before the rib is disposed in the grooved part, a height from the flange part to a tip of the rib is greater than a depth of the grooved part.

Accordingly, the rib comes into contact with the bottom surface of the grooved part in a compressed state, when the flange part is attached to the case in contact with the case. Therefore, the present disclosure can improve the adhesion between the rib and the bottom surface of the grooved part. With this, the push switch having improved waterproofness can be implemented.

In addition, for example, the push switch may further include a metallic cover. The metallic cover may press the rib against the case to a degree that the flange part and an upper surface of the case come into contact with each other.

With this, the rib can be adhered to the case in a compressed state. Accordingly, the adhesion between the rib and the case can be more improved.

Moreover, for example, in a state in which the metallic cover is pressing the flange part against the case, at least one space may be present between the rib and an inner wall of the grooved part.

Accordingly, contact between the flange part and the lateral wall part allows us to be informed of the adhesion between the rib and the bottom surface of the grooved part. In other words, it is possible to readily check the adhesion between the rib and the bottom surface of the grooved part and assurance of the waterproofness.

In addition, for example, the rubber cap may further include an operation part that presses the movable contact toward the fixed contact. The operation part may move between (i) a first position in which the movable contact and the fixed contact do not contact each other and (ii) a second position in which the movable contact and the fixed contact each other. When the operation part is at least in the second position, an inner wall of the grooved part and the rib may be in contact with each other.

Accordingly, when the rib is pulled in toward the direction of the operation part, the inner wall of the grooved part can prevent the movement of the rib toward the operation part. In other words, it is possible to prevent a reduction in the adhesion between the rib and the bottom surface of the grooved part along with the movement of the rib. Therefore, the present disclosure can implement a push switch having improved waterproofness, while readily ensuring the waterproofness.

Moreover, for example, the rib may be formed around the entire perimeter of the operation part in a top view of the push switch.

With this, it is possible to prevent the ingress of water from all directions around the perimeter. Therefore, the present disclosure can implement a push switch having even more improved waterproofness.

Hereinafter, embodiments will be described in detail with reference to the drawings.

Note that the embodiments below each describe a general or a specific example. The numerical values, shapes, elements, the arrangement and the orders of connection of the elements, etc. presented in the embodiments below are mere examples, and thus are not intended to limit the present disclosure. Furthermore, among the elements in the embodiments below, those not recited in any one of the independent claims will be described as optional elements.

In addition, the drawings are schematic diagrams, and do not necessarily provide strictly accurate illustrations. Accordingly, the drawings do not necessarily coincide with one another in terms of scales and the like. Throughout the drawings, the same reference numeral is given to substantially the same element, and redundant description is omitted or simplified.

The X axis, Y axis, and Z axis in the specification and drawings of the present disclosure indicate the three axes of a right-handed three-dimensional orthogonal coordinate system. In the embodiment, the Z axis direction is a movement direction in which the operation part of a push switch moves. In addition, a view from the Z axis direction will also be stated as top view.

In the specification of the present disclosure, terms describing relationships between elements such as parallel, terms describing shapes of elements such as a quadrilateral and an inverted trapezoid, and numerical values and numerical value ranges are not only used to express the strict meanings, but are also used to express the meanings of substantially equivalent ranges. For example, the terms, numerical values, and numerical value ranges include a difference of about several percent (e.g., about 10%).

### Embodiment

Hereinafter, a push switch according to the embodiment will be described in detail with reference to FIG. 1 through FIG. 7.

[1. Configuration of push switch]

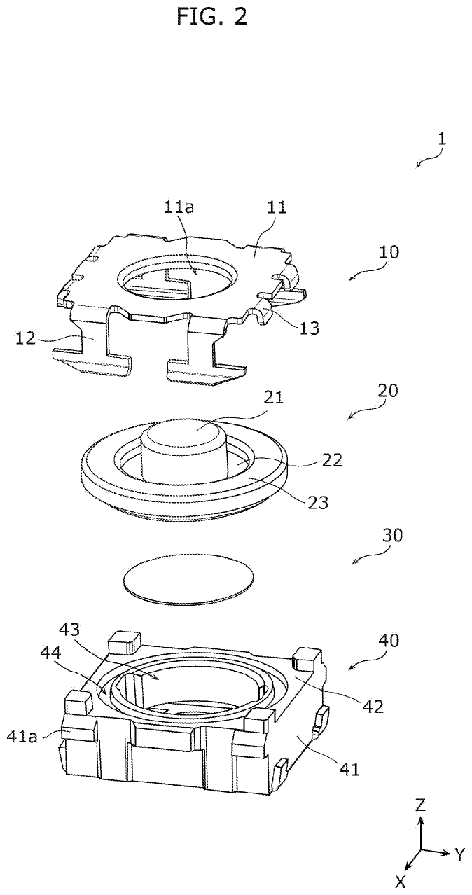

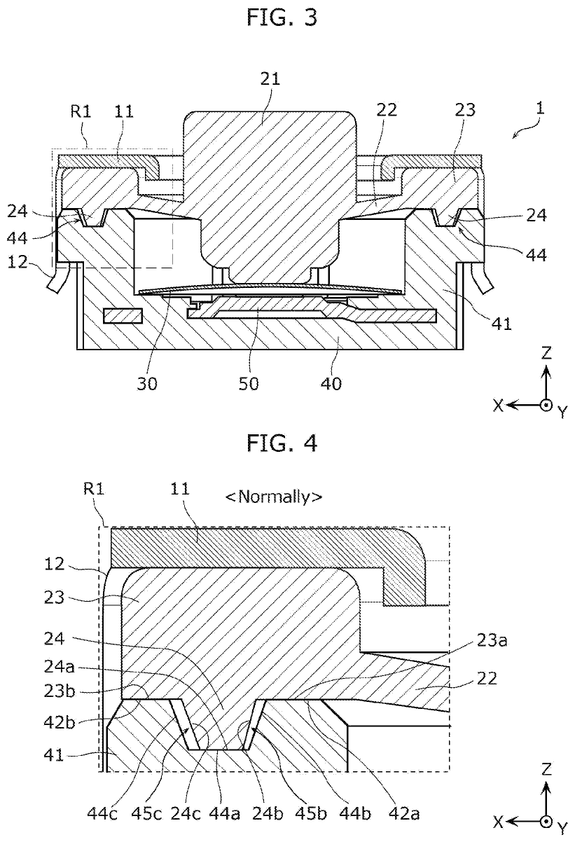

First, the configuration of a push switch according to the embodiment will be described with reference to FIG. 1 through FIG. 6. FIG. 1 is a perspective view of an external appearance of push switch 1 according to the embodiment. FIG. 2 is an exploded perspective view of push switch 1 according to the embodiment. FIG. 3 is a cross sectional view of push switch 1 according to the embodiment which is taken along line III-III shown in FIG. 1.

As illustrated in FIG. 1 through FIG. 3, push switch 1 includes metallic cover 10, rubber cap 20, movable contact 30, case 40, and fixed contact 50. Push switch 1 is characterized in that (i) rib 24 that protrudes toward case 40 (the negative side of the Z axis) is formed on rubber cap 20, and (ii) grooved part 44 in which rib 24 is to be disposed is formed in case 40 in a position that overlaps rib 24 in top view. In other words, push switch 1 has a configuration in which an elastic body is disposed in grooved part 44. Rib 24 and grooved part 44 are a protrusion and a recess, respectively, and they fit together.

In push switch 1, operation part 21 of rubber cap 20 is pushed downward (the negative direction of the Z axis), movable contact 30 is elastically deformed due to the push, and movable contact 30 and fixed contact 50 are brought into conduction. With this, push switch 1 can transmit a predetermined signal to an external receiving device using communication (e.g., wireless communication). Push switch 1 is a normally-open switch that is turned ON only when a push operation is performed. In addition, although push switch 1 is used as a portable switch, push switch 1 may be fixed to (e.g., embedded in) a building material or an electronic device to be used.

Metallic cover 10 is a plate-like metallic component that covers flange part 23 of rubber cap 20, and is fixed to case 40. In a state in which metallic cover 10 is fixed to case 40, metallic cover 10 is in contact (e.g., surface-to-surface contact) with the upper surface of flange part 23. In addition, metallic cover 10 presses flange part 23 against case 40 (toward the negative side of the Z axis) to a degree that flange part 23 and upper surface 42 of case 40 come into contact (e.g., surface-to-surface contact) with each other. Specifically, metallic cover 10 presses rib 24 of flange part 23 against case 40 to a degree that flange part 23 and upper surface 42 of case 40 come into contact with each other. More specifically, metallic cover 10 presses rib 24 of flange part 23 against bottom surface 44a (see FIG. 4) of grooved part 44 of case 40. In other words, rib 24 is in contact with bottom surface 44a of grooved part 44 in a state in which metallic cover 10 is attached to case 40.

Metallic cover 10 is in a quadrilateral shape in top view, and includes plate-like part 11, nail parts 12, and regulation parts 13. Plate-like part 11, nail parts 12, and regulation parts 13 are integrally formed.

Plate-like part 11 is a flat plate-like component, and includes insertion through-hole 11a through which the upper portion of operation part 21 is inserted. The shape of insertion through-hole 11a is dependent on the shape of operation part 21. The end portion on the internal perimeter side (insertion through-hole 11a side) of plate-like part 11 may be bent and curved toward case 40.

Nail parts 12 protrude from end portions on the positive side and the negative side of the X axis of plate-like component 11 toward case 40. Nail parts 12 fix metallic cover 10 to case 40. Nail parts 12 are caught on protruding parts 41a provided on case 40 to fix metallic cover 10 to case 40.

Regulation parts 13 are provided protruding from end portions on the positive side and the negative side of the Y axis of plate-like part 11 toward case 40. Regulation parts 13 regulate the movement of rubber cap 20 in the Y axis direction.

Note that the number of nail parts 12 and regulation parts 13 are not particularly limited.

Rubber cap 20 is a rubber elastic body provided so as to cover recessed part 43 of case 40. Rubber cap 20 includes operation part 21, connecting part 22, and flange part 23. Operation part 21, connecting part 22, and flange part 23 are integrally formed. In addition, out of operation part 21, connecting part 22, and flange part 23, only operation part 21 and connecting part 22 are exposed.

Operation part 21 receives force externally applied to push switch 1 to press movable contact 30 toward fixed contact 50 (the negative side of the Z axis). The externally-applied force is force applied to operation part 21 by an operator of push switch 1. Operation part 21 moves between (i) a first position (the position shown in FIG. 3) in which movable contact 30 and fixed contact 50 do not contact each other and (ii) a second position in which movable contact 30 and fixed contact 50 contact each other. The second position is closer to fixed contact 50 (on the negative side of the Z axis) than the first position is.

Operation part 21 has an upper portion that is exposed outside case 40, and is disposed in the position corresponding to movable contact 30. Operation part 21 is in, for example, a circular cylinder shape, but the shape is not limited to the foregoing.

Connecting part 22 is a loop-like part for connecting operation part 21 and flange part 23. Connecting part 22 seamlessly connects operation part 21 and flange part 23. In this embodiment, connecting part 22 is in a toroidal shape. The thickness of connecting part 22 (the length in the Z axis direction) is less than both the thickness of operation part 21 and the thickness of flange part 23, but the thickness of connecting part 22 is not limited to the foregoing. Connecting part 22 may be, for example, plate-like. Connecting part 22 is connected to a lower portion (first portion) of a surface on the internal perimeter side of flange part 23. In addition, connecting part 22 is connected to a second portion of operation part 21. For example, the second portion is located lower (on the negative side of the Z axis) than the first portion. In other words, connecting part 22 is an inclined part that inclines downward as it gets closer toward the center area (inner area).

Flange part 23 is a loop-like part disposed facing upper surface 42 of lateral wall part 41, and covers upper surface 42 of lateral wall part 41. Flange part 23 is in contact (e.g., surface-to-surface contact) with each of metallic cover 10 and upper surface 42 of lateral wall part 41. The cross-sectional shape of flange part 23 is quadrilateral. The upper surface (the surface on the positive side of the Z axis) of flange part 23 and the lower surface (the surface on the negative side of the Z axis) of flange part 23 excluding rib 24 are both flat surfaces. With this, it is possible to increase the contact area size between flange part 23 and metallic cover 10 and the contact area size between flange part 23 and upper surface 42 of lateral wall part 41.

Flange part 23 includes, on the lower surface, rib 24 that protrudes toward case 40. Rib 24 and flange part 23 are integrally formed. Rib 24 is disposed in grooved part 44 of lateral wall part 41. Rib 24 is formed in a loop-like shape in top view. In this embodiment, rib 24 is formed in a toroidal shape about operation part 21. Rib 24 is formed around the entire perimeter of operation part 21 in top view. Rib 24 is unbrokenly and continuously formed, for example.

Note that rib 24 may be formed in, for example, a quadrilateral shape or a spiral shape in top view. Moreover, formation of rib 24 is not limited to continuous formation. For example, rib 24 may be formed in a discrete loop-like shape. In addition, a plurality of ribs 24 having different diameters may be concentrically formed. In other words, a plurality of ribs 24 may be provided.

In top view, rib 24 is provided in the vicinity of the center of flange part 23, but rib 24 may be provided closer to the center area or on the outer perimeter side, as long as rib 24 can come into contact with bottom surface 44a. In addition, the protruding direction of rib 24 is, for example, parallel to the movement direction of operation part 21.

Movable contact 30 is a plate-like component having electrical conductivity and elasticity which is disposed in the position facing fixed contact 50. Movable contact 30 can be moved between (i) an ON position in which a movable contact portion (e.g., the center portion) and a fixed contact portion of fixed contact 50 contact each other and (ii) an OFF position in which the movable contact portion and the fixed contact portion are separated from each other. In this embodiment, movable contact 30 is in a dome shape whose perimeter is fixed to case 40. Movable contact 30 is configured such that the center portion can be moved between the ON position and the OFF position. Movable contact 30 is normally in a dome shape that protrudes toward the positive side of the Z axis. Movable contact 30 elastically deforms by the force applied from operation part 21, and comes into contact with fixed contact 50. This elastic deformation gives feeling of clicking (feeling of pressing operation) to a user. Note that FIG. 3 illustrates a cross-section of a state in which the center portion is in the OFF position.

Movable contact 30 is, for example, a metallic plate such as stainless steel (SUS), and is a flat spring in this embodiment. Note that movable contact 30 is not limited to a metallic material as long as movable contact 30 has electrical conductivity.

Case 40 includes recessed part 43 in which movable contact 30 and the lower portion of operation part 21 are accommodated. Fixed contact 50 is embedded in case 40. Case 40 includes loop-like lateral wall part 41 and the bottom surface part that seals one opening (an opening on the negative side of the Z axis) of lateral wall part 41. Lateral wall part 41 and the bottom surface part are integrally formed. Lateral wall part 41 is vertically disposed from the outer edge of the bottom surface part toward the positive side of the Z axis, and forms the inner surface of recessed part 43. Case 40 includes resin. In addition, case 40 is harder than rubber cap 20.

Protruding parts 41a with which nail parts 12 engage are provided at the four corners of the outer surface of lateral wall part 41. Note that the positions and the number of protruding parts 41a are not particularly limited. Grooved part 44 in which rib 24 is to be disposed is formed in upper surface 42 of lateral wall part 41. Grooved part 44 is an indentation formed in upper surface 42 which is hollowed downward (the negative side of the Z axis). Grooved part 44 is formed in a position that overlaps rib 24 in top view. Grooved part 44 is formed in a loop-like shape surrounding recessed part 43 in top view. In this embodiment, grooved part 44 is formed in a toroidal shape in top view, but the shape is not limited to the foregoing. The shape of grooved part 44 is to be dependent on the shape of rib 24. In addition, the cross section of grooved part 44 is in an inverted trapezoid shape. The size of grooved part 44 is to be large to a degree that rib 24 compressed by metallic cover 10 being attached to case 40 can be accommodated.

Fixed contact 50 is a plate-like electrode (fixed electrode) having electrical conductivity which comes into contact with the movable contact portion of movable contact 30. Fixed contact 50 includes a material having electrical conductivity. Fixed contact 50 is connected to a board (printed circuit board) provided inside case 40 (e.g., inside recessed part 43). For example, the board is provided with electronic components, such as a power supply circuit, a control circuit, a memory, and a transmission circuit. The board detects that a push operation is performed on operation part 21 by movable contact 30 and fixed contact 50 being brought into conduction, and transmits a predetermined signal to an external receiving device.

Here, rib 24 and grooved part 44 will be further described with reference to FIG. 4 through FIG. 6. FIG. 4 is a partially enlarged cross sectional view of dashed-line region R1 enclosed by the dashed line shown in FIG. 3. Rib 24 has tip 24a and side surfaces 24b and 24c. In addition, the inner surface of grooved part 44 is formed by bottom surface 44a and side surfaces 44b and 44c. In this embodiment, side surfaces 44b and 44c are inclined surfaces inclined at a predetermined angle relative to bottom surface 44a. The cross section of side surfaces 44b and 44c can be said to be in a tapered shape whose groove width (a length in the X axis direction) narrows from the opening of grooved part 44 toward bottom surface 44a. Note that side surface 44b forms an inner wall (inner-side wall) on the inner side of grooved part 44, and side surface 44c forms an inner wall (outer-side wall) on the outer side of grooved part 44.

As illustrated in FIG. 4, tip 24a of rib 24 adheres to bottom surface 44a of grooved part 44. Since tip 24a is pressed against case 40 by metallic cover 10, tip 24a elastically deforms and comes into surface-to-surface contact with bottom surface 44a of grooved part 44. Since tip 24a is compressed by press applied by metallic cover 10, rib 24 has the cross section that is in an inverted trapezoid shape. With this, an interior space of case 40 and an external space of push switch 1 can be separated. In other words, the interior of case 40 can be hermetically sealed. Note that pressing against case 40 by metallic cover 10 means that rib 24 is being pressed by metallic cover 10 against case 40 while metallic cover 10 is fixed to case 40. The foregoing is a constantly applied press in a product state in which all elements are assembled as shown in FIG. 1. In addition, adhering means that tip 24a of rib 24 comes into contact with bottom surface 44a in an elastically deformed state, for example.

In a state in which metallic cover 10 is pressing flange part 23 against case 40, space 45b is present between rib 24 and side surface 44b of grooved part 44, and space 45c is present between rib 24 and side surface 44c of grooved part 44. Specifically, side surface 24b and side surface 44b are not in contact with each other, and space 45b is present therebetween. In addition, side surface 24c and side surface 44c are not in contact with each other, and space 45c is present therebetween. Spaces 45b and 45c are, for example, air spaces. Spaces 45b and 45c each may be, for example, a hermetically sealed space.

Note that at least one of space 45b and space 45c is to be present. The maximum width of grooved part 44 (in the example shown in FIG. 4, the length of the opening of grooved part 44 in the X axis direction) is greater than the maximum width of rib 24 (in the example shown in FIG. 4, the length of from the lower surface 23a side to the lower surface 23b side of rib 24 in the X axis direction) while metallic cover 10 is fixed to case 40 and rib 24 is being compressed.

In addition, lower surface 23a and upper surface 42a face each other and are parallel to each other. Lower surface 23b and upper surface 42b face each other, and are parallel to each other. In a state in which metallic cover 10 is fixed to case 40, lower surface 23a and upper surface 42a are in contact (e.g., surface-to-surface contact) with each other and lower surface 23b and upper surface 42b are in contact (e.g., surface-to-surface contact) with each other. Lower surface 23a is a portion of the lower surface of flange part 23 which is closer to the center area than rib 24 is, and lower surface 23b is a portion of the lower surface of flange part 23 which is closer to the outer side than rib 24 is. Lower surfaces 23a and 23b are flat surfaces, and lower surface 23a is flush with lower surface 23b. Moreover, upper surface 42a is a portion of upper surface 42 of lateral wall part 41 which is closer to the center area than grooved part 44 is, and upper surface 42b is a portion of upper surface 42 of lateral wall part 41 which is closer to the outer side than grooved part 44 is. Upper surfaces 42a and 42b are flat surfaces, and upper surface 42a is flush with upper surface 42b.

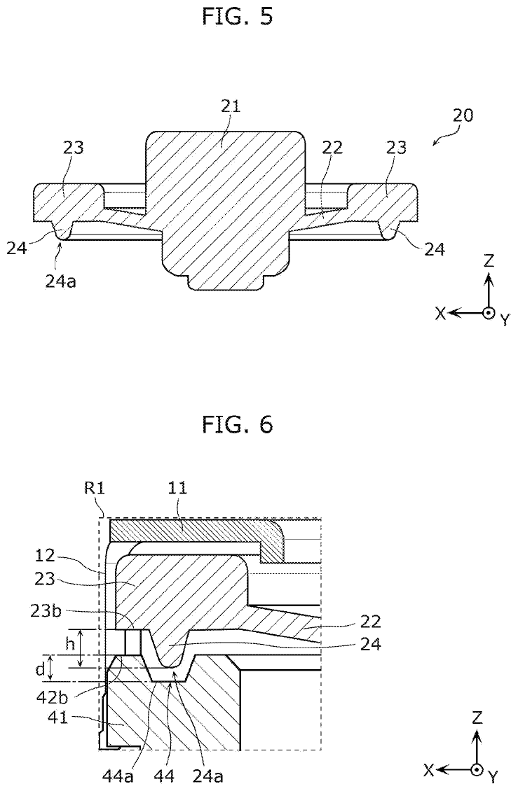

Next, the shape of rib 24 in an uncompressed state will be described with reference to FIG. 5. FIG. 5 is a cross sectional view of rubber cap 20 according to the embodiment.

As illustrated in FIG. 5, rib 24 has tip 24a that is a round projection, but tip 24a may be a quadrilateral (e.g., trapezoidal) projection in a cross section of tip 24a or in any shape as long as tip 24a can be in contact with bottom surface 44a. In addition, height h (see FIG. 6) of rib 24 is less than the height (length in the Z axis direction) of flange part 23.

Next, the length of each of rib 24 and grooved part 44 will be described with reference to FIG. 6. FIG. 6 is a partially exploded view of elements in dashed-line region R1 shown in FIG. 3.

As illustrated in FIG. 6, in a state before rib 24 is disposed in grooved part 44 (e.g., a state in which metallic cover 10 is not pressing rib 24 against case 40), height h of rib 24 is greater than depth d of grooved part 44. Accordingly, rib 24 can be adhered to bottom surface 44a of grooved part 44, thereby further improving waterproofness of push switch 1. Moreover, the volume of rib 24 is less than the volume (capacity) of grooved part 44. For example, the area size of rib 24 in cross-sectional view is smaller than the area size of grooved part 44 in the cross-sectional view. With these reasons, a check on contact between lower surface 23a and upper surface 42a and contact between lower surface 23b and upper surface 42b allow us to be informed of the adhesion between rib 24 and bottom surface 44a (tip 24a is in contact with bottom surface 44a in a compressed state). For example, when the volume of rib 24 is greater than the volume of grooved part 44, flange part 23 is unattached (a state in which flange part 23 is not in contact with upper surface 42 of case 40) in a state in which metallic cover 10 is fixed to case 40. Accordingly, it is not readily possible to check whether rib 24 is in contact with bottom surface 44a.

Note that height h is the length between lower surface 23b of flange part 23 and tip 24a of rib 24 in the Z axis direction, and depth d is the length between bottom surface 44a of grooved part 44 and upper surface 42b in the Z axis direction.

### [2. Movement When Push Operation is Performed]

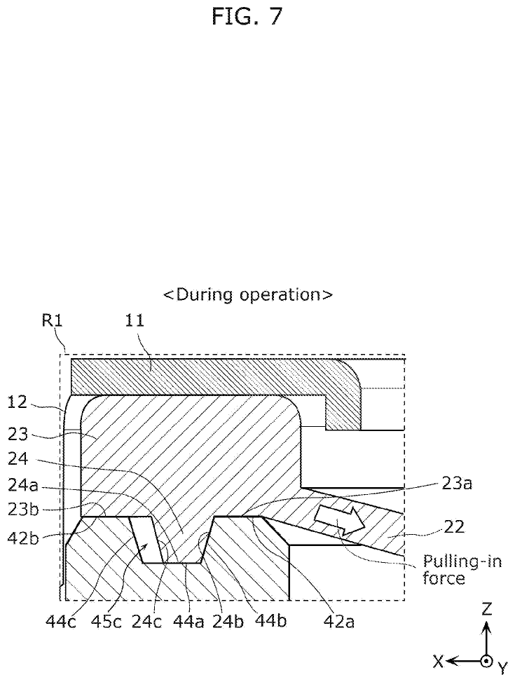

Next, movements made in push switch 1 configured as described above when a push operation is performed will be described with reference to FIG. 7. FIG. 7 is a partially enlarged cross sectional view of dashed-line region R1 shown in FIG. 3, when a push operation is performed on operation part 21 of push switch 1 according to the embodiment. FIG. 7 is a partially enlarged cross sectional view of push switch 1 when an operation is performed by a user.

When a push operation is performed on push switch 1, operation part 21 moves from the first position to the second position. This generates pulling-in force that pulls flange part 23 connected with operation part 21 in toward the center area (the operation part 21 side). Accordingly, flange part 23 and rib 24 move toward the center area from the state shown in FIG. 4, and are to be in the state shown in FIG. 7.

As illustrated in FIG. 7, flange part 23 moving toward the center area brings side surface 24b of rib 24 into contact with side surface 44b of lateral wall part 41. Side surface 24b comes into surface-to-surface contact with side surface 44b, for example. For example, no space is present between side surface 24b and side surface 44b. As described above, rib 24 contacts side surface 44b of grooved part 44 when operation part 21 is at least in the second position.

With this, a movement of rib 24 toward the center area is regulated by side surface 44b. Accordingly, a movement of flange part 23 that is integrally formed with rib 24 toward the center area is also regulated. In addition, since case 40 is harder than rib 24, case 40 does not deform even though force corresponding to pulling-in force is applied to case 40. In other words, side surface 24b can maintain rib 24 in the position shown in FIG. 7 when a push operation is performed.

Here, although a push operation is performed, a positional relationship between metallic cover 10 and case 40 does not change. Accordingly, a state in which rib 24 is pressed against case 40 is maintained. In other words, even when a push operation is performed, tip 24a of rib 24 and bottom surface 44a of grooved part 44 continue adhering to each other. Therefore, even when a push operation is performed, push switch 1 has waterproofness equivalent to the waterproofness normally offered. Stated differently, as compared to push switch 100 according to the comparative example, push switch 1 has improved waterproofness when a push operation is performed.

In addition, space 45c is present inside grooved part 44 even when a push operation is performed. As described above, normally and when a push operation is performed, the inside of grooved part 44 is not filled with rib 24, and a space is present inside grooved part 44.

Moreover, the following states are also maintained when a push operation is performed: a state in which lower surface 23a and upper surface 42a are in contact (e.g., surface-to-surface contact) with each other, and a state in which lower surface 23b and upper surface 42b are in contact (e.g., surface-to-surface contact) with each other. With this, it is possible to readily check adhesion between rib 24 and bottom surface 44a even when a push operation is performed.

Note that, normally, the width (the length in the X axis direction in the example shown in FIG. 7) at which lower surface 23a and upper surface 42a are in surface-to-surface contact with each other and the width (the length in the X axis direction in the example shown in FIG. 7) at which lower surface 23b and upper surface 42b are in surface-to-surface to-surface contact with each other may be greater than a distance within which rib 24 is movable in grooved part 44 in the X axis direction, for example. For example, the above-described widths may be greater than the width (the length in the X axis direction) of space 45c shown in FIG. 7. Note that the width of space 45c shown in FIG. 7 is greater than the width of space 45c shown in FIG. 4. With this, it is possible to maintain contact between lower surface 23a and upper surface 42a and contact between lower surface 23b and upper surface 42b normally and when a push operation is performed.

In addition, heat may be applied to push switch 1 during manufacturing. For example, heat may be applied to push switch 1 in a product state as shown in FIG. 1. The above may be exemplified by a reflowing process. In this case, air inside push switch 1 expands due to heat, and thus flange part 23 and rib 24 move toward the outer perimeter (the positive side of X axis in the example shown in FIG. 7). The movement of flange part 23 toward the outer perimeter brings side surface 24c of rib 24 into contact with side surface 44c of lateral wall part 41. Side surface 24c comes into surface-to-surface contact with side surface 44c, for example. For example, no space is present between side surface 24c and side surface 44c.

With this, a movement of rib 24 toward the outer perimeter is regulated by side surface 44c. Accordingly, a movement of flange part 23 that is integrally formed with rib 24 toward the outer perimeter is also regulated. Since case 40 is harder than rib 24, case 40 does not deform even though force corresponding to the air expansion is applied from rib 24. In other words, side surface 44c can maintain rib 24 in the position in which side surface 44c and rib 24 come into surface-to-surface contact with each other when heat is applied.

Here, although heat is applied, a positional relationship between metallic cover 10 and case 40 does not change. Accordingly, a state in which rib 24 is pressed against case 40 is maintained. In other words, even when heat is applied, tip 24a of rib 24 and bottom surface 44a of grooved part 44 continue adhering to each other. Specifically, even when heat is applied, push switch 1 can maintain adhesion between tip 24a of rib 24 and bottom surface 44a of grooved part 44. With this, it is possible to prevent an occurrence of an in-process defect.

### Other Embodiments

Hereinbefore, push switch 1 according to one or more aspects has been described based on the embodiment; however, the present disclosure is not limited to the embodiment. The present disclosure may encompass embodiments to which various modifications that may be conceived by those skilled in the art are made and embodiments achieved by combining elements in different embodiments, as long as resultant embodiments do not depart from the scope of the present disclosure.

For example, in the above-described embodiment, an example of push switch 1 that is in a quadrilateral shape in top view has been described. However, the shape in top view is not limited to the foregoing. Push switch 1 may be in a round shape, a polygonal shape, etc.

In addition, in the above-described embodiment, an example of push switch 1 provided with a cover that is metallic cover 10 has been described. However, the cover is not limited to the foregoing. The cover may be a resin cover, etc.

Moreover, in the above-described embodiment, an example of push switch 1 that is provided with metallic cover 10 has been described. However, push switch 1 need not be provided with metallic cover 10. For example, at least a portion of flange part 23 may be exposed. In this case, push switch 1 may be provided with a component to cause flange part 23 to be caught on protruding part 41a of case 40, or a projection to be caught on protruding part 41a may be formed on flange part 23.

In addition, in the above-described embodiment, an example in which operation part 21 and movable contact 30 are normally in contact with each other has been described. However, operation part 21 and movable contact 30 may be disposed with a predetermined space therebetween.

Moreover, in the above-described embodiment, an example in which fixed contact 50 is embedded in case 40 has been described. However, fixed contact 50 need not be embedded as long as fixed contact 50 is attached to case 40 without being deformed.

In addition, in the above-described embodiment, an example of rubber cap 20 that includes three elements (operation part 21, connecting part 22, and flange part 23) having different thicknesses has been described. However, the configuration of rubber cap 20 is not limited to the foregoing. Rubber cap 20 may be, for example, a sheet-like component like a rubber sheet. Rib 24 may be a projection that protrudes from a sheet-like component toward case 40. In this case, an object (an object that presses movable contact 30 downward) may be interposed between sheet-like rubber cap 20 (a rubber sheet) and movable contact 30. In other words, rubber cap 20 need not include a portion that directly presses movable contact 30 toward fixed contact 50 (the negative side of the Z axis).

In addition, in the above-described embodiment, an example of grooved part 44 whose cross section is in an inverted trapezoid shape has been described. However, the cross-sectional shape is not limited to the foregoing. The cross section of grooved part 44 may be in a quadrilateral shape or any other shapes. The cross-sectional shape of grooved part 44 may be dependent on the cross-sectional shape of rib 24 whose tip 24a is in a compressed state.

### INDUSTRIAL APPLICABILITY

The present disclosure is useful for push switches that are required to have waterproofness.

### REFERENCE SIGNS LIST

1 push switch
10 metallic cover
11 plate-like part
11a insertion through-hole
12 nail part
13 regulation part
20 rubber cap
21 operation part
22 connecting part
23 flange part
23a, 23b lower surface
24 rib
24a tip
24b, 24c, 44b, 44c side surface
30 movable contact
40 case
41 lateral wall part
41a protruding part
42, 42a, 42b upper surface
43 recessed part
44 grooved part
44a bottom surface
45b, 45c space
50 fixed contact
d depth
h height
R1 dashed-line region

1. A push switch comprising:
a movable contact;
a fixed contact that comes into contact with the movable contact;
a case that includes a recessed part accommodating the movable contact and in which the fixed contact is embedded; and
a rubber cap that covers the recessed part of the case, wherein
the rubber cap includes a rib that protrudes toward the case,
the case further includes a lateral wall part that forms an inner surface of the recessed part,
the lateral wall part has an upper surface in which a grooved part is formed, and
the rib is disposed in the grooved part of the lateral wall part.

2. The push switch according to claim 1, wherein
the lateral wall part is in a loop-like shape in a top view of the push switch,
the grooved part is formed in the upper surface of the lateral wall part in a loop-like shape, and
the rib is formed in a loop-like shape.

3. The push switch according to claim 1, wherein
the rubber cap further includes a flange part that covers the upper surface of the lateral wall,
the rib is formed on the flange part, and
in a state before the rib is disposed in the grooved part, a height from the flange part to a tip of the rib is greater than a depth of the grooved part.

4. The push switch according to claim 3, further comprising:
a metallic cover, wherein
the metallic cover presses the rib against the case to a degree that the flange part and an upper surface of the case come into contact with each other.

5. The push switch according to claim 4, wherein
in a state in which the metallic cover is pressing the flange part against the case, at least one space is present between the rib and an inner wall of the grooved part.

6. The push switch according to claim 1, wherein
the rubber cap further includes an operation part that presses the movable contact toward the fixed contact,
the operation part moves between (i) a first position in which the movable contact and the fixed contact do not contact each other and (ii) a second position in which the movable contact and the fixed contact contact each other, and
when the operation part is at least in the second position, an inner wall of the grooved part and the rib are in contact with each other.

7. The push switch according to claim 6, wherein
the rib is formed around an entire perimeter of the operation part in a top view of the push switch.
